(19) United States
(12) Patent Application Publication
(10) Pub. No.: US 2017/0155123 A1
(43) Pub. Date: Jun. 1, 2017

(54) NONAQUEOUS ELECTROLYTE SECONDARY BATTERY LAMINATED SEPARATOR, NONAQUEOUS ELECTROLYTE SECONDARY BATTERY MEMBER, AND NONAQUEOUS ELECTROLYTE SECONDARY BATTERY

(71) Applicant: Sumitomo Chemical Company, Limited, Tokyo (JP)

(72) Inventor: Hirohiko HASEGAWA, Niihama-shi (JP)

(21) Appl. No.: 15/363,572

(22) Filed: Nov. 29, 2016

(30) Foreign Application Priority Data
Nov. 30, 2015 (JP) 2015-233932

(51) Int. Cl. H01M 2/16; H01M 10/0525

(52) U.S. Cl. CPC H01M 2/1686; H01M 10/0525; H01M 2/1653; H01M 2220/30

(57) ABSTRACT

Provided is a nonaqueous electrolyte secondary battery laminated separator that is excellent in on-heating shape retainability and ion permeability and that allows a reduction in occurrence of a current leakage despite being thin.

This Nonprovisional application claims priority under-35 U.S.C. §119 on Patent Application No. 2015-233932 filed in Japan on Nov. 30, 2015, the entire contents of which are hereby incorporated by reference.

### TECHNICAL FIELD

The present invention relates to a laminated separator for a nonaqueous electrolyte secondary battery (hereinafter referred to as a “nonaqueous electrolyte secondary battery laminated separator”), a member for a nonaqueous electrolyte secondary battery (hereinafter referred to as a “nonaqueous electrolyte secondary battery member”), and a nonaqueous electrolyte secondary battery.

### BACKGROUND ART

Nonaqueous electrolyte secondary batteries, especially lithium secondary batteries, each of which has a high energy density, have been widely used as batteries for use in, for example, a personal computer, a mobile phone, and a portable information terminal.

Such a nonaqueous electrolyte secondary battery, typified by a lithium secondary battery, may let a large current flow and generate intense heat in a case where an accident such as a breakage in the battery or in a device using that battery has caused an internal or external short circuit. This risk has created a demand that a nonaqueous electrolyte secondary battery should prevent more than a certain level of heat generation to ensure a high level of safety.

Safety of a nonaqueous electrolyte secondary battery is typically ensured by imparting, to a separator included in the nonaqueous electrolyte secondary battery, a shutdown function of, in a case where abnormal heat generation has occurred, blocking passage of ions between a cathode and an anode so that further heat generation is prevented. Examples of a method for imparting the shutdown function to a separator include a method in which a porous film, made of a material that is meltable by abnormal heat generation, is used as the separator. That is, according to a battery that includes a separator made of such a porous film, in a case where abnormal heat generation occurs, the separator is melted, made non-porous, and thereby blocks passage of ions. This allows further heat generation to be suppressed.

As a separator having swell a shutdown function, a porous film made of a polyolefin can be, for example, used. In a case where abnormal heat generation occurs in a battery, a separator made of the porous film is melted at a temperature of approximately 80° C. to 180° C. (for example, a separator made of a polyethylene porous film is melted at a temperature of approximately 110° C. to 160° C.), made non-porous, and thereby blocks (shuts down) passage of ions. This prevents further heat generation. There have been proposed various methods for producing a porous film made of a polyolefin and having such a shutdown function (see Patent Literatures 1, 2, and 3).

However, in a case where intense heat, generation occurs, a separator made of the porous film may me, for example, contracted or broken and accordingly cause a cathode and an anode to come into direct contact with each other. This may cause a short circuit. As such, a separator made of a porous film that is made of a poly olefin has insufficient shape stability, and therefore does not always allow abnormal heat generation caused by a short circuit to be suppressed.

In view of the above circumstances, as a nonaqueous electrolyte secondary battery separator that is excellent in shape stability at high temperatures (i.e., on-heating shape retainability), there has been proposed a nonaqueous electrolyte secondary battery separator made of a laminated porous film which is configured such that a heat-resistant layer is laminated to a porous film (Patent Literatures 4 and 5).

### CITATION LIST

### Patent Literature

[Patent Literature 1]

Japanese Patent Application Publication Tokukaisho No. 60-242035 (Publication date: Dec. 2, 1985)

[Patent Literature 2]

Japanese Patent Application Publication Tokukaihei No. 10-261393 (Publication date: Sep. 29, 1998)

[Patent Literature 3]

Japanese Patent Application Publication Tokukai No. 2002-69221 (Publication date: Mar. 8, 2002)

[Patent Literature 4]

Japanese Patent Application Publication Tokukai No. 2000-30686 (Publication date: Jan. 28, 2000)

[Patent Literature 5]

Japanese Patent Application Publication Tokukai No. 2004-22 7972 (Publication date: Aug. 12, 2004)

### SUMMARY OF INVENTION

### Technical Problem

An expansion in use of lithium secondary batteries has created a demand that a lithium secondary battery should have a higher energy density. An energy density of a battery can be easily increased by (i) reducing a thickness of a laminated separator and (ii) correspondingly increasing an amount of each of a cathode and an anode. However, according to this method, the laminated separator is likely to be seriously damaged due to unevenness of the cathode and the anode (see FIG. 3) and accordingly becomes poor in insulation property, which is an original function of the laminated separator. This may ultimately cause an increase in current leakage during initial assembly of the battery. Occurrence of the current leakage can be suppressed by decreasing a porosity of the laminated separator. However, such a decrease in porosity also causes a decrease in ion permeability of the laminated separator.

The present invention has been made in view of the above problems, and an object of an embodiment of the present invention is to provide (i) a nonaqueous electrolyte secondary battery laminated separator that is excellent in on-heating shape retainability and ion permeability and that allows a reduction in occurrence of a current leakage despite being thin, (ii) a nonaqueous electrolyte secondary battery member including the nonaqueous electrolyte secondary battery laminated separator, and (iii) a nonaqueous electrolyte secondary battery including the nonaqueous electrolyte secondary battery laminated separator.

### Solution to Problem

The inventors of the present invention found for the first time that a rate of occurrence of a current leakage is interrelated with a difference in melting behavior between a nonaqueous electrolyte secondary battery laminated separator and a porous film obtained by removing a heat-resistant layer from the nonaqueous electrolyte secondary battery laminated separator. The inventors have, as a result, completed the present invention.

A nonaqueous electrolyte secondary battery laminated separator in accordance with an embodiment of the present invention includes a porous film containing a polyolefin as a main component; and a heat-resistant layer, the nonaqueous electrolyte secondary battery laminated separator having a film thickness of 8 μm to 20 μm, the nonaqueous electrolyte secondary battery laminated separator having a Gurley air permeability of not more than 250 sec/100 cc, the nonaqueous electrolyte secondary battery laminated separator satisfying the following Expression (1):

0.70≦S_{PC}/S_{C}≦0.81 Expression (1)

where: S_{C} represents an area of an endothermic peak in a first DSC curve, the first DSC curve being obtained by performing differential scanning calorimetry (DSC) on pieces, each having a given size, that have been cut out from the nonaqueous electrolyte secondary battery laminated separator and that are stacked; and S_{PC} represents an area of part of the endothermic peak in the first DSC curve which part overlaps an endothermic peak in a second DSC curve, the second DSC curve being obtained by performing DSC on pieces, each having a given size, that have been cut out from the porous film obtained by removing the heat-resistant layer from the nonaqueous electrolyte secondary battery laminated separator and that are stacked.

A nonaqueous electrolyte secondary battery member in accordance with an embodiment of the present invention includes: a cathode; a nonaqueous electrolyte secondary battery laminated separator mentioned above; and an anode, the cathode, the nonaqueous electrolyte secondary battery laminated separator, and the anode being provided in this order.

A nonaqueous electrolyte secondary battery in accordance with an embodiment of the present invention includes a nonaqueous electrolyte secondary battery laminated separator mentioned above.

### Advantageous Effects of Invention

According to an embodiment of the present invention, it is possible to provide a nonaqueous electrolyte secondary battery laminated separator that is excellent in on-heating shape retainability and ion permeability and that allows a reduction in occurrence of a current leakage despite being thin.

### BRIEF DESCRIPTION OF DRAWINGS

FIG. 1 is a schematic view illustrating how a DSC curve changes between a nonaqueous electrolyte secondary battery laminated separator and a porous film obtained by removing a heat-resistant layer from the nonaqueous electrolyte secondary battery laminated separator.

FIG. 2 is a graph showing how S_{PC}/S_{C} is related to the current leakage occurrence rate in each of Examples and Comparative Examples.

FIG. 3 is a schematic view illustrating how a reduction in thickness of a laminated separator causes a current leakage.

### DESCRIPTION OF EMBODIMENTS

An embodiment of the present invention is described below. Note, however, that the present invention is not limited to such an embodiment. The present invention is not limited to arrangements described below, but can be altered by a skilled person in the art within the scope of the claims. An embodiment derived from a proper combination of technical means each disclosed in a different embodiment is also encompassed in the technical scope of the present invention. Note that a numerical range “A to B” herein means “not less than A and not more than B” unless otherwise specified.

[1. Nonaqueous Electrolyte Secondary Battery Laminated Separator]

A nonaqueous electrolyte secondary battery laminated separator in accordance with an embodiment of the present invention is provided between a cathode and an anode of a nonaqueous electrolyte secondary battery. The nonaqueous electrolyte secondary battery laminated separator includes (i) a porous film containing a polyolefin-based resin as a main component and (ii) a heat-resistant layer laminated to at least one side of the porous film.

The nonaqueous electrolyte secondary battery laminated separator has a film thickness of 8 μm to 20 μm and more preferably of 10 μm to 16 μm. A reduction in film thickness of the nonaqueous electrolyte secondary battery laminated separator makes it possible to (i) increase an amount of each of the cathode and the anode and (ii) ultimately increase an energy density of the nonaqueous electrolyte secondary battery.

The nonaqueous electrolyte secondary battery laminated separator has a Gurley air permeability of not more than 250 sec/100 cc and more prefer ably of not more than 200 sec/100 cc, so as to obtain sufficient ion permeability.

As described earlier, a nonaqueous electrolyte secondary battery laminated separator having a film thickness of 8 μm to 20 μm makes it possible to increase an energy density of a nonaqueous electrolyte secondary battery. However, such a nonaqueous electrolyte secondary battery laminated separator is likely to cause a current leakage. A nonaqueous electrolyte secondary battery laminated separator having a Gurley air permeability of not more than 250 sec/100 cc is excellent in ion permeability. However, such a nonaqueous electrolyte secondary battery laminated separator is likely to cause a current leakage, because the nonaqueous electrolyte secondary battery laminated separator contains a resin in a small amount.

In view of the above, the inventors of the present invention made a diligent study and, as a result, found for the first time that a rate of occurrence of a current leakage is interrelated with a difference in melting behavior between a nonaqueous electrolyte secondary battery laminated separator and a porous film obtained by removing a heat-resistant layer from the nonaqueous electrolyte secondary battery laminated separator. The inventors have thus completed the nonaqueous electrolyte secondary battery laminated separator of an embodiment of the present invention, which laminated separator, despite having the above film thickness and air permeability, allows occurrence of a current leakage to be suppressed.

Specifically, the inventors focused their attention on an area of an endothermic peak, corresponding to crystalline melting, in a chart (hereinafter, referred to as a “DSC curve”) obtained by performing differential scanning calorimetry (DSC), and defined a range of a proportion of (i) an area of part of an endothermic peak in a DSC curve obtained by performing DSC on the nonaqueous electrolyte secondary battery laminated separator, which part overlaps an endothermic peak in another DSC curve obtained by performing DSC on the porous film obtained by removing the heat-resistant layer from the laminated separator, to (ii) an area of the endothermic peak in the DSC curve obtained by performing the DSC on the nonaqueous electrolyte secondary battery laminated separator. Note that the term “an area of an endothermic peak” refers to an area of a region surrounded by a DSC curve and a baseline, which is calculated from part of the DSC curve which part does not form an endothermic peak.

Note that a method for removing the heat-resistant layer is not limited to a particularly method. The heat-resistant layer can be removed, for example, by peeling with use of a tape or by dissolution with use of a solvent that dissolves the heat-resistant layer.

Specifically, seventeen 3-millimeter square pieces are cut out from the nonaqueous electrolyte secondary battery laminated separator, stacked and placed in an aluminum pan, and then subjected to DSC at a temperature increase rate of 10° C./min, so as to obtain a first DSC curve. Furthermore, seventeen 3-millimeter square pieces are cut out from the porous film obtained by removing the heat-resistant layer from the nonaqueous electrolyte secondary battery laminated separator, stacked and placed in an aluminum pan, and then subjected to DSC at a temperature increase rate of 10° C./min, so as to obtain a second DSC curve. A proportion (=S_{PC}/S_{c}) of (i) an area S_{PC} of part of an endothermic peak in the first DSC curve which part overlaps an endothermic peak in the second DSC curve to (ii) an area S_{c} of the endothermic peak in the first DSC curve satisfies the following Expression (1):

0.70≦S_{PC}/S_{c}≦0.81 Expression (1)

Note that the part of the endothermic peak in the first DSC curve, which part overlaps that in the second DSC curve, indicates part of a region surrounded by the first DSC curve and a baseline obtained from the first DSC curve, which part overlaps a region surrounded by the second DSC curve and a baseline obtained from the second DSC curve.

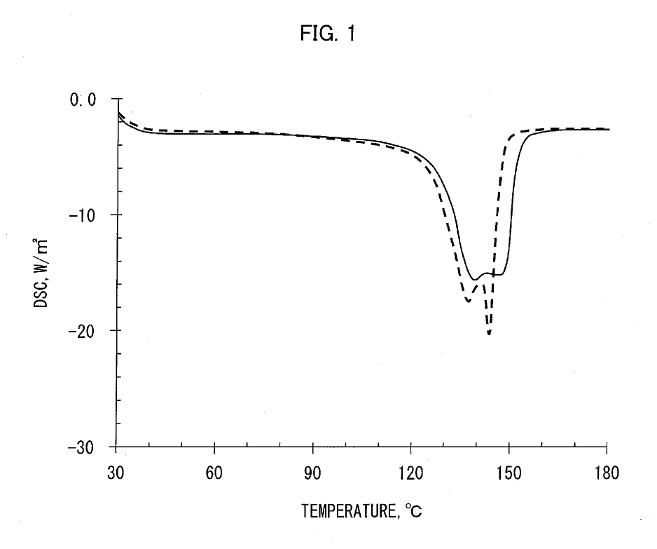

FIG. 1 is a schematic view illustrating the second DSC curve (dotted line) and the first DSC curve (solid line). According to an example illustrated in FIG. 1, an endothermic peak can be observed in a temperature range of approximately 120° C. to 160° C., and the endothermic peak in the first DSC curve is shifted to a high-temperature side of that in the second DSC curve. Note here that, for reasons later described, in the temperature range in which the endothermic peak of the porous film can be observed, an amount of heat absorbed by the heat-resistant layer is so small as to be neglected, as compared with that of heat absorbed by the porous film. That is, a cause of such a shift of the endothermic peak resides in that a melting behavior of the porous film varies depending on a crystalline state of the porous film which crystalline state varies depending on whether or not the heat-resistant layer is laminated to the porous film.

That is, the shift of the endothermic peak indicates a difference between (i) the melting behavior of the porous film (e.g., polyethylene porous film) whose surface is covered with the heat-resistant layer and (ii) that of the porous film whose surface is not covered with the heat-resistant layer. In a case where a porous film whose surface is not covered with a heat-resistant layer is melted, the porous film shrinks in both of a surface direction and a thickness direction. In contrast, in a case where the porous film whose surface is covered with the heat-resistant layer is melted, the porous film shrinks only in the thickness direction. Thus, it is considered that, by evaluating a difference between (i) a melting behavior of a nonaqueous electrolyte secondary battery laminated separator and (ii) that of a porous film obtained by removing a heat-resistant layer from the nonaqueous electrolyte secondary battery laminated separator, it is possible to evaluate, for example, to what extent polyolefin crystals contained in the porous film are out of alignment with respect to the surface direction. Note that each of these DSC curves indicates a result of measuring an amount of heat per unit area of a single sheet of the nonaqueous electrolyte secondary battery laminated separator,

As shown in Examples (later described), it is confirmed that a nonaqueous electrolyte secondary battery laminated separator which satisfies the above Expression (1) has a low current leakage occurrence rate, as compared with a nonaqueous electrolyte secondary battery laminated separator which does not satisfy Expression (1). Therefore, the nonaqueous electrolyte secondary battery laminated separator which satisfies Expression (1) makes it possible to suppress occurrence of a current leakage. Particularly, in a case where a non-aqueous electrolyte secondary battery laminated separator having a film thickness of 8 μm to 20 μm and a Gurley air permeability of not more than 250 sec/100 cc, which laminated separator easily causes a current leakage, is arranged so as to satisfy Expression (1), it is possible to remarkably achieve an effect of the present invention.

In addition, the nonaqueous electrolyte secondary battery laminated separator has an MD elastic force preferably of not less than 8 N/mm and more preferably of not less than 10 N/mm. Note that the MD elastic force indicates a product of (i) a tensile elastic, modulus in a machine direction (MD direction, longitudinal direction) of the nonaqueous electrolyte secondary battery laminated separator and (ii) a film thickness of the nonaqueous electrolyte secondary battery laminated separator. This allows an improvement in handleability of the nonaqueous electrolyte secondary battery laminated separator during production.

[1-1. Porous Film]

The porous film is produced by stretching a film that contains a polyolefin-based resin as a main component (that is, polyolefin). The porous film is a film that has therein pores connected to one another and that allows a gas or a liquid to pass therethrough from one surface to the other.

The porous film is melted and made non-porous, in a case where heat is generated in the battery. This allows the nonaqueous electrolyte secondary battery laminated separator to have a shutdown function. The porous film can be made up of a single layer or a plurality of layers.

The porous film has a film thickness preferably of 3 μm to 16 μm and more preferably of 5 μm to 14 μm. This makes it possible to (i) reduce the film thickness of the nonaqueous electrolyte secondary battery laminated separator and (ii) correspondingly increase the amount of each of the cathode and the anode. This ultimately makes it possible to increase the energy density of the nonaqueous electrolyte secondary battery.

The porous film has a Gurley air permeability preferably of 50 sec/100 cc to 200 sec/100 cc and more preferably of 60 sec/100 cc to ISO sec/100 cc, so as to obtain sufficient ion permeability when being used as part of the nonaqueous electrolyte secondary battery laminated separator.

The porous film can contain a component, such as an additive, different from a polyolefin, provided that the component does not impair a function of the porous film. The porous film contains a poly olefin component in the proportion normally of not less than 50% by volume, and preferably of not less than 90% by volume of the entire porous film. Alternatively, the proportion can also be not less than 9.5% by volume, not less than 97% by volume, or not less than 99% by volume of the entire porous film. In a case where the porous film is a polyethylene porous film that contains polyethylene as a main component, the polyethylene porous film contains polyethylene in the proportion preferably of not less than 95% by volume of the entire polyethylene porous film. Alternatively, the proportion can also be not less than 97% by volume or not less than 99% by volume of the entire polyethylene porous film. Examples of the additive include an organic compound (organic additive), and examples of the organic compound include an antioxidant (organic antioxidant) and a lubricant.

Examples of the polyolefin-based resin of which the porous film is made include high molecular weight homopolymers and high molecular weight copolymers which homopolymers and copolymers are each obtained by polymerizing ethylene, propylene, 1-butene, 4-methyl-1-pentene, 1-hexene, or the like. Of these polymers, a high molecular weight polyethylene which is mainly made of ethylene and which has a weight average molecular weight of not less than 1,000,000 is preferable. Note that the porous film can contain a component different from a polyolefin, provided that the component does not impair a function of the porous film.

The porous film has, on a volume basis, a porosity preferably of 20% by volume to 80% by volume and more preferably of 30% by volume to 75% by volume so as to (i) retain an increased amount of an electrolyte and (ii) achieve a function of absolutely preventing (shutting down) a flow of excessive electric current at a lower temperature.

The porous film has a weight per unit area normally of 4 g/m² to 12 g/m² and preferably of 5 g/m² to 8 g/m² because the porous film which has a weight per unit, area falling within the above range can increase not only a strength, a thickness, handleability, and a weight thereof but also a weight energy density and a volume energy density of the nonaqueous electrolyte secondary battery for which the porous film is used.

A method for producing the porous film containing a polyolefin-based resin as a main component is not limited to any particular one, provided that (i) the porous film, having a crystalline state which varies depending on whether or not the heat-resistant layer is provided and depending on which the melting behavior of the porous film varies (later described), can be produced and (ii) the method includes a stretching step. Examples of the method include those disclosed in Patent Literatures 1 through 3. Specifically, in the case where the porous film is produced by use of a polyolefin resin containing (i) an ultra-high molecular weight polyethylene and (ii) a low molecular weight polyolefin having a weight average molecular weight of not more than 10,000, the porous film is, from the viewpoint of production cost, preferably produced by the following method.

That is, the porous film can be obtained by a method including the steps of: (1) kneading (a) 100 parts by weight of a ultra-high molecular weight polyethylene, (b) 5 parts by weight to 200 parts by weight of a low molecular weight polyolefin having a weight average molecular weight of not more than 10,000, and (c) 100 parts by weight to 400 parts by weight of a pore-forming agent, such as calcium carbonate or a plasticizer, to obtain a polyolefin resin composition; (2) forming a sheet by use of the polyolefin resin composition: (3) removing the pore-forming agent from the sheet obtained in the step (2); and (4) stretching the sheet obtained in the step (3).

According to the above method, by optimizing a mixing ratio of the polyolefin-based resin composition and/or optimizing a processing condition, such as a temperature during formation or stretching of the sheet, depending on the mixing ratio and/or a film thickness of the sheet, it is possible to obtain the porous film arranged such that S_{PC}/S_{c} satisfies the above Expression (1), i.e., the porous film having a crystalline state which varies depending on whether or not the heat-resistant layer is provided and depending on which the melting behavior of the porous film varies.

It is also possible to increase the MD elastic force of the porous film and of the nonaqueous electrolyte secondary battery laminated separator by, in the step (2), winding up the sheet in the MD direction at a given stretch ratio. The stretch ratio refers to a ratio of a speed of a winding roller to a speed of a reduction roller (winding roller speed/reduction roller speed).

(1-2) Heat-Resistant Layer

The heat-resistant layer imparts, to the porous film, shape stability at high temperatures. That is, the heat-resistant layer lists a heat resistance higher than that of the porous film. It follows that the melting behavior of the porous film does not match that of the heat-resistant layer. Even if an endothermic peak in a DSC curve obtained from the heat-resistant layer overlaps an endothermic peak of a DSC curve obtained from the porous film, the melting behavior of the heat-resistant layer merely has a limited and extremely small influence on the melting behavior of the porous film because, as described above, the heat-resistant layer has a heat resistance higher than that of the porous film. The heat-resistant layer is preferably insoluble in the electrolyte of the battery and is preferably electrochemically and thermally stable in a range of use of the battery.

The heat-resistant layer contains a resin, and preferably further contains a filler. Each of the resin and the filler which are contained in the heat-resistant layer is preferably insoluble in the electrolyte of the battery, and is preferably electrochemically and thermally stable in the range of use of the battery.

In a case where the heat-resistant layer contains the filler, the heat-resistant layer can contain the filler in the proportion of not less than 1% by volume and not more than 99% by volume of the entire heat-resistant layer.

In a case where a lower one of (i) a glass transition temperature of and (ii) a melting point of the resin contained in the heat-resistant layer is lower than 16° C., i.e., lower than a melting temperature range of the polyethylene porous film, the heat-resistant layer contains the filler in the proportion preferably of not less than 90% by volume and not more than 99% by volume, more preferably of not less than 93% by volume and not more than 99% by volume, still more preferably not less than 95% by volume and not more than 99% by volume, and most preferably not less than 97% by volume and not more than 99% by volume of the entire heat-resistant layer. The heat-resistant layer which contains the filler in the proportion falling within the above ranges has a sufficient heat resistance. This causes the amount of heat absorbed by the heat-resistant layer to be so small as to be neglected, in the temperature range in which the endothermic peak of the porous film can be observed, as compared with that of heat absorbed by the porous film.

In a case where a lower one of (i) the glass transition temperature of and (ii) the melting point of the resin contained in the heat-resistant layer is lower than 160° C., i.e., lower than the melting temperature range of the polyethylene porous film, the resin contained in the heat-resistant layer has a weight per unit area preferably of not more than 0.2, more preferably not more than 0.11, and still more preferably not more than 0.04, relative to the weight per unit area of the porous film. In a case where the heat-resistant layer contains the resin in the proportion falling within the above ranges, the amount of heat absorbed by the heat-resistant layer is so small as to be neglected, in the temperature range in which the endothermic peak of the porous film can be observed, as compared with that of heat absorbed by the porous film.

That is, the heat-resistant layer in accordance with an embodiment of the present invention is preferably (i) a layer that contains a resin whose glass transition temperature and melting point are both higher than a melting temperature of the polyethylene porous film, (ii) a layer that contains a filler in the proportion of not less than 90% by volume and not more than 99% by volume of the entire layer, or (iii) a layer that contains a resin having a weight per unit area of not more than 0.2 relative to the weight per unit area of the porous film.

The heat-resistant layer is laminated to one side or both sides of the porous film. The heat-resistant layer that is laminated to one side of the porous film is preferably laminated to a surface of the porous film which surface faces the cathode of the nonaqueous electrolyte secondary battery which includes the laminated separator, and is more preferably laminated to a surface of the porous film which surface is in contact with the cathode.

A film thickness of the heat-resistant layer only needs to be determined as appropriate in view of the film thickness of the nonaqueous electrolyte secondary battery laminated separator. However, the film thickness of the heat-resistant layer is preferably 2 μm to 10 μm and more preferably 3 μm to 8 μm (in total, in a case where the heat-resistant layer is laminated to the both sides of the porous film).

A weight per unit area of the heat-resistant layer only needs to be determined as appropriate in view of the strength, film thickness, weight, and handleability of the nonaqueous electrolyte secondary battery laminated separator. However, the weight per unit area of the heat-resistant layer is preferably 1 g/m₂ to 10 g/m₂ and more preferably 2 g/m₂ to 8 g/m².

Examples of the resin contained in the heat-resistant layer include: polyolefins such as polyethylene, polypropylene, polybutene, and an ethylene-propylene copolymer; fluorine-containing resins such as polyvinylidene fluoride (PVDF) and polytetrafluoroethylene; fluorine-containing rubbers such as a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer; aromatic polyamide; wholly aromatic polyamide (aramid resin); rubbers such as a styrene-butadiene copolymer and a hydride thereof, a methacrylate ester copolymer, an acrylonitrile-acrylic ester copolymer, a styrene-acrylic ester copolymer, ethylene propylene rubber, and polyvinyl acetate; resins having a melting point or a glass transition temperature of not less than 180° C., such as polyphenylene ether, polysulfone, polyether sulfone, polyphenylene sulfide, polyetherimide, polyamide-imide, polyether amide, and polyester; water-soluble polymers such as polyvinyl alcohol, polyethylene glycol, cellulose ether, sodium alginate, polyacrylic acid, polyacrylamide, and polymethacrylic acid; and the like. Of these resins, a heat-resistant resin whose glass transition temperature and melting point are both higher than the melting temperature of the porous film is preferable. Examples of such a heat-resistant resin include polyamide, polyimide, polyamide-imide, polycarbonate, polyacetal, polysulfone, polyphenylene sulfide, polyether ether ketone, aromatic polyester, polyether sulfone, polyetherimide, cellulose ether, and the like. Each of these heat-resistant resins can be used solely or two or more kinds of the heat-resistant resins can be used in combination.

Examples of the filler contained in the heat-resistant layer include a filler made of an inorganic matter such as calcium carbonate, talc, clay, kaolin, silica, hydrotalcite, diatomaceous earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, and glass. The heat-resistant layer can contain (i) only one kind of filler or (ii) two or more kinds of fillers in combination.

Among the above fillers, a filler made of silica, calcium oxide, magnesium oxide, titanium oxide, alumina, mica, or zeolite is more preferable. A filler made of silica, magnesium oxide, titanium, oxide, or alumina is still more preferable. A filler made of alumina is particularly preferable. Alumina has many crystal forms such as α-alumina, β-alumina, γ-alumina, and θ-alumina, and any of the crystal forms can be suitably used. Among the above crystal forms, α-alumina, which is particularly high in thermal stability and chemical stability, is the most preferable.

Examples of a method for forming the heat-resistant layer include: a method in which a coating solution containing (i) a component of the heat-resistant layer and (ii) a solvent (hereinafter, also referred to simply as “coating solution”) is directly applied to the surface of the porous film and then the solvent (dispersion medium) is removed; a method in which the coating solution is applied to an appropriate support, the heat-resistant layer is formed by removing the solvent (dispersion medium), and thereafter the heat-resistant layer thus formed and the porous film are pressure-bonded and subsequently the support is peeled off; a method in which the coating solution is applied to the appropriate support and then the porous film is pressure-bonded to an application surface, and subsequently the support is peeled off and then the solvent (dispersion medium) is removed; a method in which the porous film is immersed in the coating solution so as to be subjected to dip coating, and thereafter the solvent (dispersion medium) is removed; and the like.

The heat-resistant layer can have a thickness that is controlled by adjusting, for example, a thickness of a coated film that is moist (wet) after being coated, a weight ratio between the resin and the filler, and/or a solid content concentration (a sum of a resin concentration and a filler concentration) of the coating solution. Note that it is possible to use, as the support, a film made of resin, a belt made of metal, or a drum, for example.

A method for applying the coating solution to the porous film or the support is not particularly limited to any specific method, provided that the method achieves a necessary weight per unit area and a necessary coating area. The coating solution can be applied to the porous film or the support, by a conventionally publicly known method.

Generally, the solvent (dispersion medium) is removed by drying. Examples of a drying method include natural drying, air-blowing drying, heat drying, vacuum drying, and the like. Note, however, that any drying method is usable provided that the drying method allows the solvent (dispersion medium) to be sufficiently removed. For the drying, it is possible to use an ordinary drying device.

Further, it is possible to carry out the drying after replacing, with another solvent, the solvent (dispersion medium) contained in the coating solution. Examples of a method for removing the solvent (dispersion medium) after replacing the solvent (dispersion medium) with another solvent include a method in which another solvent (hereinafter, referred to as a solvent X) is used that is dissolved in the solvent (dispersion medium) contained in the coating solution and does not dissolve the resin contained in the coating solution, the porous film or the support on which a coated film has been formed by application of the coating solution is immersed in the solvent X, the solvent (dispersion medium) contained in the coated film formed on the porous film or the support is replaced with the solvent X, and thereafter the solvent X is evaporated. This method makes it possible to efficiently remove the solvent (dispersion medium) from the coating solution.

Assume that heating is carried out so as to remove the solvent (dispersion medium) or the solvent X from the coated film of the coating solution which coated film has been formed on the porous film or the support. In this case, in order to prevent the porous film from having a lower air permeability due to contraction of pores of the porous film, it is desirable to carry out heating at a temperature at which the porous film does not have a lower air permeability, specifically, 10° C. to 120° C., more preferably 20° C. to 80° C.

[2. Nonaqueous Electrolyte Secondary Battery Member, Nonaqueous Electrolyte Secondary Battery]

A nonaqueous electrolyte secondary battery member in accordance with an embodiment of the present invention is a nonaqueous electrolyte secondary battery member including a cathode, a nonaqueous electrolyte secondary battery laminated separator, and an anode that are provided in this order. A nonaqueous electrolyte secondary battery in accordance with an embodiment of the present invention includes a nonaqueous electrolyte secondary battery laminated separator. The following description is given by (i) taking a lithium ion secondary battery member as an example of the nonaqueous electrolyte secondary battery member and (ii) taking a lithium ion secondary battery as an example of the nonaqueous electrolyte secondary battery. Note that components of the nonaqueous electrolyte secondary battery member or the nonaqueous electrolyte secondary battery except the nonaqueous electrolyte secondary battery laminated separator are not limited to those discussed In the following description.

In the nonaqueous electrolyte secondary battery in accordance with an embodiment of the present invention, it is possible to use, for example, a nonaqueous electrolyte obtained by dissolving lithium salt in an organic solvent. Examples of the lithium salt include LiClO₄, LiPF₆, LiAsF₆, LiSbFf₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, LiAlCl₄, and the like. The above lithium salts can be used in only one kind or in combination of two or more kinds. Of the above lithium salts, at least one kind of fluorine-containing lithium salt selected from the group consisting of LiPF₆, LiAsF₆, LiSbF₆, LiBF₄, LiCF₃SO₃, LiN(CF₃SO₂)₂, and LiC(CF₃SO₂)₃ is more preferable.

Specific examples of the organic solvent of the nonaqueous electrolyte include: carbonates such as ethylene carbonate, propylene carbonate, dimethyl carbonate, diethyl carbonate, ethyl methyl carbonate, 4-trifluoromethyl-1,3-dioxolane-2-one, and 1,2-di(methoxycarbonyloxy)ethane; ethers such as 1,2-dimethoxyethane, 1,3-dimethoxypropane, pentafluoropropylmethyl ether, 2,2,3,3-tetrafluoropropyldifluoromethyl ether, tetrahydrofuran, and 2-methyltetrahydrofuran; esters such as methyl formate. methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethylsulfoxide, and 1,3-propanesultone; a fluorine-containing organic solvent obtained by introducing a fluorine group in the organic solvent; and the like. The above organic solvents can be used in only one kind or in combination of two or more kinds. Of the above organic solvents, a carbonate is more preferable, and a mixed solvent of cyclic carbonate and acyclic carbonate or a mixed solvent of cyclic carbonate and an ether is more preferable. The mixed solvent of cyclic carbonate and acyclic carbonate is more preferably exemplified by a mixed solvent containing ethylene carbonate, dimethyl carbonate, and ethyl methyl carbonate. This is because the mixed solvent containing ethylene carbonate, dimethyl carbonate, and ethyl methyl carbonate operates in a wide temperature range, and is refractory also in a case where a graphite material such as natural graphite or artificial graphite is used as an anode active material.

Normally, a sheet cathode in which a cathode current collector supports thereon a cathode mix containing a cathode active material, an electrically conductive material, and a binding agent is used as the cathode.

Examples of the cathode active material include a material that is capable of doping and dedoping lithium ions. Specific examples of such a material include lithium complex oxides each containing at least one kind of transition metal selected from the group consisting of V, Mn, Fe, Co, and Ni. Of the above lithium complex oxides, a lithium complex oxide having an α-NaFeO₂ structure, such as lithium nickel oxide or lithium, cobalt, oxide, or a Lithium complex oxide having a spinel structure, such as lithium manganate spinel is more preferable. This is because such a lithium complex oxide is high in average discharge potential. The lithium complex oxide can contain various metallic elements, and a lithium nickel complex oxide is more preferable. Further, it is particularly preferable to use lithium nickel complex oxide which contains at least one kind of metallic element so that the at least one kind of metallic element accounts for 0.1 mol % to 20 mol % of a sum of the number of moles of the at least one kind of metallic element and the number of moles of Ni in lithium nickel oxide, the at least one kind of metallic element being selected from the group consisting of Ti, Zr, Ce, Y, V, Cr, Mn, Fe, Co, Cu, Ag, Mg, Al, Ga, In, and Sn. This is because such lithium nickel complex oxide is excellent in cycle characteristic during use of the nonaqueous electrolyte secondary battery at a high capacity. Especially an active material which contains Al or Mn and has an Ni content of not less than 85% and more preferably of not less than 90% is particularly preferable. This is because such an active material is excellent in cycle characteristic during use of the nonaqueous electrolyte secondary battery at a high capacity, the nonaqueous electrolyte secondary battery including the cathode containing the active material.

Examples of the electrically conductive material include carbonaceous materials such as natural graphite, artificial graphite, cokes, carbon black, pyrolytic carbons, carbon fiber, organic high molecular compound baked bodies, and the like. The above electrically conductive materials can be used in only one kind. Alternatively, the above electrically conductive materials can be used in combination of two or more kinds by, for example, mixed use of artificial graphite and carbon black.

Examples of the binding agent include polyvinylidene fluoride, a vinylidene fluoride copolymer, polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-tetrafluoroethylene copolymer, a vinylidene fluoride-trifluoromethylene copolymer, a vinylidene fluoride-trichloroethylene copolymer, and a vinylidene fluoride-vinyl fluoride copolymer, a vinylidene fluoride-hexafluoropropylene-tetrafluoroethylene copolymer, thermoplastic resins such as thermoplastic polyimide, thermoplastic polyethylene, and thermoplastic polypropylene, acrylic resin, and styrene butadiene rubber. Note that the binding agent also functions as a thickener.

The cathode mix can be obtained by, for example, pressing the cathode active material, the electrically conductive material, and the binding agent on the cathode current, collector, or causing the cathode active material, the electrically conductive material, and the binding agent to be in a form of paste by use of an appropriate organic solvent.

Examples of the cathode current collector include electrically conductive materials such as Al, Ni, and stainless steel. Of the above examples, Al, which is easy to process into a thin film and less expensive, is more preferable.

Examples of a method for producing the sheet cathode, i.e., a method for causing the cathode current collector to support the cathode mix include: a method in which the cathode active material, the electrically conductive material, and the binding agent which are to be formed into the cathode mix are pressure-molded on the cathode current collector; a method in which the cathode current collector is coated with the cathode mix which has been obtained by causing the cathode active material, the electrically conductive material, and the binding agent to be in a form of paste by use of an appropriate organic solvent, and a sheet cathode mix obtained by drying is pressed so as to be closely fixed to the cathode current collector; and the like.

Normally, a sheet anode in which an anode current collector supports thereon an anode mix containing an anode active material is used as the anode. The sheet anode preferably contains the electrically conductive material and the binding agent.

Examples of the anode active material include a material that is capable of doping and dedoping lithium ions, lithium metal or lithium alloy, and the like. Specific examples of such a material include: carbonaceous materials such as natural graphite, artificial graphite, cokes, carbon black, pyrolytic carbons, carbon fiber, and organic high molecular compound baked bodies; chalcogen compounds such as oxides and sulfides each doping and dedoping lithium ions at a lower potential than that of the cathode; metals such as aluminum (Al), lead (Pb), tin (Sn), bismuth (Bi), and silicon (Si) each alloyed with an alkali metal; cubic intermetallic compounds (AlSb, Mg₂Si, NiSi₂) having lattice spaces in which alkali metals can be provided; lithium nitrogen compounds (Li₃₋ₓMₓN (M: transition metal)); and the like. Of the above anode active materials, a carbonaceous material which contains, as a main component, a graphite material such as natural graphite or artificial graphite is preferable. This is because such a carbonaceous material is high in potential evenness, and a great energy density can foe obtained in a case where the carbonaceous material, which is low in average discharge potential, is combined with the cathode. An anode active material which is a mixture of graphite and silicon and has an Si-to-C ratio of not less than 5% is more preferable, and an anode active material which is a mixture of graphite and silicon and has an Si-to-C ratio of not less than 10% is still more preferable.

The anode mix can be obtained by, for example, pressing the anode active material on the anode current collector, or causing the anode active material to be in a form of paste by use of an appropriate organic solvent.

Examples of the anode current collector include Cu, Ni, stainless steel, and the like. Of the above examples, Cu, which is difficult to alloy with lithium particularly in a lithium ion secondary battery and easy to process into a thin film, is more preferable.

Examples of a method for producing the sheet anode, i.e., a method for causing the anode current collector to support the anode mix include: a method in which the anode active material to be formed into the anode mix is pressure-molded on the anode current collector; a method in which the cathode current collector is coated with the anode mix which has been obtained by causing the anode active material to be in a form of paste by use of an appropriate organic solvent, and a sheet anode mix obtained by drying is pressed so as to be closely fixed to the anode current collector; and the like. The paste preferably contains the electrically conductive material and the binding agent.

The nonaqueous electrolyte secondary battery member in accordance with an embodiment of the present invention is formed by providing the cathode, the nonaqueous electrolyte secondary battery laminated separator, and the anode in this order. Thereafter, the nonaqueous electrolyte secondary battery member is placed in a container serving as a housing of the nonaqueous electrolyte secondary battery. Subsequently, the container is filled with a nonaqueous electrolyte, and then the container is sealed while being decompressed. The nonaqueous electrolyte secondary battery in accordance with an embodiment of the present invention can thus be produced. The nonaqueous electrolyte secondary battery, which is not particularly limited in shape, can have any shape such as a sheet (paper) shape, a disc shape, a cylindrical shape, or a prismatic shape such as a rectangular prismatic shape. Note that, a method for producing the nonaqueous electrolyte secondary battery is not particularly limited to any specific method, and a conventionally publicly known production method can be employed as the method.

### EXAMPLES

The following description more specifically describes the present invention with reference to Examples and Comparative Examples. Note, however, that the present invention is not limited to those Examples and Comparative Examples.

<Method for Measuring Various Physical Properties>

Various physical properties of nonaqueous electrolyte secondary battery laminated separators in accordance with the following Examples and Comparative Examples were measured by the methods below.

(1) Film Thickness

A film thickness D (μm) of a nonaqueous electrolyte secondary battery laminated separator was measured in conformity with the Japanese Industrial Standard (JIS K 7130-1992).

(2) Weight Per Unit Area

A 10-centimeter square piece was cut out from the nonaqueous electrolyte secondary battery laminated separator, and a weight W1 (g) of that square piece was measured. Next, a heat-resistant layer was peeled from the square piece once with use of a tape (Scotch, manufactured by 3M) so as to obtain a porous film, and a weight W2 (g) of the porous film was measured. A weight per unit area of each of the porous film and the heat-resistant layer was calculated by the following equations.

Weight per unit area of porous film (g/m²)=W2/(0.1×0.1)

Weight per unit, area of heat-resistant layer (g/m²)=(W1−W2)/(0.1×0.1)

(3) Air Permeability

An air permeability of the nonaqueous electrolyte secondary battery laminated separator was measured in conformity with JIS P8117, by use of a digital timer Gurley Type Densometer manufactured by Toyo Seiki Seisaku-sho, Ltd.

(4) MD Elastic Force

An MD elastic force of the nonaqueous electrolyte secondary battery laminated separator was calculated by multiplying the film thickness by a tensile elastic modulus in an MD direction of the nonaqueous electrolyte secondary battery laminated separator which tensile elastic modulus had been measured in conformity with ASTM-D882.

(5) DSC Measurement

Seventeen 3-millimeter square pieces were cut out from the nonaqueous electrolyte secondary battery laminated separator, and then stacked and placed in an aluminum pan (diameter: 5 mm). An aluminum lid was placed on the aluminum pan, and then the aluminum pan and the aluminum lid were swaged together by use of a specialized jig. A measurement sample A was thus prepared.

Similarly, seventeen 3-millimeter square pieces were cut out from a porous film obtained by removing a heat-resistant layer from the nonaqueous electrolyte secondary battery laminated separator, and then stacked and placed in an aluminum pan (diameter: 5 mm). An aluminum lid was placed on the aluminum pan, and then the aluminum pan and the aluminum lid were swaged together by use of a specialized jig. A measurement sample B was thus prepared.

Each of those measurement samples was subjected to DSC at a temperature increase rate of 10° C./min, by use of DSC-7020 manufactured by Seiko Instruments Inc., so as to obtain a DSC curve. In each of Examples and Comparative Examples, an amount of heat per unit area of a single sheet of the nonaqueous electrolyte secondary battery laminated separator or the porous film was calculated.

S_{C} and S_{PC} were then calculated from DSC curves thus obtained (horizontal axis: temperature, vertical axis: DSC (W/m²)).

Note that S_{C} represents an area of a region surrounded by (i) a baseline (first baseline) that was obtained by performing the DSC on the measurement sample A and (ii) the DSC curve (first DSC curve) that was obtained by performing the DSC on the measurement sample A (i.e., an area of an endothermic peak in the first DSC curve). Note also that S_{PC} represents an area of part of the region surrounded by the first baseline and the first DSC curve which part overlaps a region surrounded by (i) a baseline (second baseline) that was obtained by performing the DSC on the measurement sample B and (ii) the DSC curve (second DSC curve) that was obtained by performing the DSC on the measurement sample B (i.e., part of the endothermic peak in the first DSC curve which part overlaps that in the second DSC curve).

(6) Current Leakage Occurrence Rate

The nonaqueous electrolyte secondary battery laminated separator was sandwiched between abrasive paper #1000, a cylinder having a diameter of 25 mm was placed thereon, and then a weight (total weight of the cylinder and the weight: 4 kg) was placed thereon for 10 seconds. An electrode of a withstand voltage tester (IMP3800, manufactured by Nippon Technart Inc.), which electrode had a diameter of 25 mm and a weight of 500 g, was placed on a pressured part of the porous film, and a breakdown voltage was measured.

The above operation was repeated 10 times, and the number of times that the breakdown voltage was not more than 0.9 kV was regarded as a current leakage occurrence rate.

<Preparation of Nonaqueous Electrolyte Secondary Battery Laminated Separator>

First, a coating solution A and a coating solution B described below were prepared each as a coating solution for forming a heat-resistant layer to be laminated to a porous film.

(Coating Solution A)

Poly(paraphenylene terephthalamide) was produced by use of a 3-liter separable flask having a stirring blade, a thermometer, a nitrogen inlet tube, and a powder addition port. First, 2200 g of N-methyl-2-pyrrolidone (NMP) was introduced into the flask that had been sufficiently dried. Then, 151.07 g of calcium chloride powder that had been vacuum-dried at 200° C. for 2 hours was added to the NMP. A resultant mixture was heated to 100° C. so that the calcium chloride powder was completely dissolved in the NMP. A resultant solution was cooled to a room temperature, and 68.23 g of paraphenylene diamine was added to and completely dissolved in the solution. While this solution was kept at 20° C.±2° C., 124.97 g of terephthalic acid dichloride was added to the solution in 10 divided portions at intervals of approximately 5 minutes. The solution thus obtained was then aged for 1 hour while being stirred and kept at 20° C.±2° C. Thereafter, the solution was filtered by use of a 1500-mesh stainless-steel gauze. The solution thus obtained had a para-aramid concentration of 6%. Next, 100 g of this para-aramid solution was weighed out and poured into a flask. Then, 300 g of NMP was added to the para-aramid solution to prepare a solution having a para-aramid concentration of 1.5% by weight. The solution having a para-aramid concentration of 1.5% by weight was stirred for 60 minutes, then mixed with 6 g of alumina C (manufactured by Nippon Aerosil Co., Ltd.) and 6 g of advanced alumina AA-03(manufactured by Sumitomo Chemical Co., Ltd.), and stirred for 240 minutes. The solution thus obtained was filtered by use of a 1000-mesh metal gauze. Thereafter, 0.73 g of calcium oxide was added to the solution thus filtered. The solution was stirred for 240 minutes for neutralization, and then defoamed under reduced pressure. The coating solution A was thus obtained in slurry form.

(Coating Solution B)

To 35% by weight aqueous ethanol solution, carboxymethyl cellulose (CMC, manufactured by Daicel FineChem Ltd.: 1110) and alumina (manufactured by Sumitomo Chemical Co., Ltd.: AKP3000) were added at a weight ratio of 4:100 so that a solid content concentration of a resultant solution became 20% by weight. A resultant solution was mixed, and then treated three times under a high-pressure dispersion condition (50 MPa) with use of a Gorlin homogenizer. The coating solution B was thus prepared.

Nonaqueous electrolyte secondary battery laminated separators in accordance with respective Examples 1 through 4 and Comparative Examples 1 through 3 were produced as below by use of the coating solution A or the coating solution B.

### Example 1

First, 80% by weight of ultra-high molecular weight polyethylene powder (GUR4012, manufactured by Ticona Corporation) and 20% by weight of polyethylene wax (FNP-0115, manufactured by Nippon Seiro Co., Ltd.) having a weight average molecular weight of 1,000 were prepared. That is, 100 parts by weight, in total, of the ultra-high molecular weight polyethylene powder and the polyethylene wax were prepared. To the ultra-high molecular weight polyethylene powder and the polyethylene wax, 0.4% by weight of an antioxidant (Irg1010, manufactured by Ciba Specialty Chemicals Corporation), 0.1% by weight of another antioxidant (P168, manufactured by Ciba Specialty Chemicals Corporation), and 1.3% by weight of sodium stearate were added. Further, calcium carbonate (manufactured by Maruo Calcium Co., Ltd.) having an average particle size of 0.1 μm was added so that the calcium carbonate accounted for 37% by volume of a total volume of all these compounds. The compounds were mixed in a powder state by use of a Henschel mixer, and melt-kneaded by use of a twin screw kneading extruder. A polyolefin resin composition was thus obtained.

The polyolefin resin composition was rolled by use of a pair of reduction rollers each having a surface temperature of 145° C., and then cooled in stages while being pulled by use of a winding roller that rotated at a speed different from that of the pair of reduction rollers (stretch ratio (winding roller speed/reduction roller speed): 1.4 times). A sheet having a film thickness of approximately 54 μm was thus prepared. This sheet was immersed in an aqueous hydrochloric solution (in which 4 mol/L of hydrochloric acid and 0.5% by weight of a non-ionic surfactant were blended) so that the calcium carbonate was removed, and then stretched 5.8-fold in a traverse direction (TD direction, width direction) at 105° C. A porous film was thus obtained.

The coating solution A was applied to one surface of the porous film, and deposited at a temperature of 50° C. and a humidity of 70% for 1 minute. The porous film on which the coating solution A was deposited was cleaned with running water for 5 minutes, and then dried in an oven at 70° C. for 5 minutes so that a heat-resistant layer was formed. A nonaqueous electrolyte secondary battery laminated separator was thus obtained. Conditions under which the nonaqueous electrolyte secondary battery laminated separator was produced are summarized in Table 1. Properties of the nonaqueous electrolyte secondary battery laminated separator thus obtained are summarized in Table 2.

For obtainment of a DSC curve, the heat-resistant layer was removed by three times of peeling by use of a tape (Scotch, manufactured by 3M). A DSC measurement result and a current leakage occurrence rate are summarized in Table 3.

### Example 2

First, 80% by weight of ultra-high molecular weight polyethylene powder (GUR4012, manufactured by Ticona Corporation) and 20% by weight of polyethylene wax (FNP-0115, manufactured by Nippon Seiro Co., Ltd.) having a weight average molecular weight of 1,000 were prepared. That is, 100 parts by weight, in total, of the ultra-high molecular weight polyethylene powder and the polyethylene wax were prepared. To the ultra-high molecular weight polyethylene powder and the polyethylene wax, 0.4% by weight of an antioxidant (Irg1010, manufactured by Ciba Specialty Chemicals Corporation), 0.1% by weight of another antioxidant (P168, manufactured by Ciba Specialty Chemicals Corporation), and 1.3% by weight of sodium stearate were added. Further, calcium carbonate (manufactured by Maruo Calcium Co., Ltd.) having an average particle size of 0.1 μm was added so that the calcium carbonate accounted for 41% by volume of a total volume of all these compounds. The compounds were mixed in a powder state by use of a Henschel mixer, and melt-kneaded by use of a twin screw kneading extruder. A polyolefin resin composition was thus obtained.

The polyolefin resin composition was rolled by use of a pair of reduction rollers each having a surface temperature of 150° C., and then cooled in stages while being pulled by use of a winding roller that rotated at a speed different from that of the pair of reduction rollers (stretch ratio (winding roller speed/reduction roller speed): 1.3 times). A sheet, having a film thickness of approximately 54 μm was thus prepared. This sheet was immersed in an aqueous hydrochloric solution (in which 4 mol/L of hydrochloric acid and 0.5% by weight of a non-ionic surfactant were blended) so that the calcium carbonate was removed, and then stretched 5.8-fold in the TD direction at 105C. A porous film was thus obtained.

The coating solution A was applied to one surface of the porous film, and deposited at a temperature of 50° C. and a humidity of 70% for 1 minute. The porous film on which the coating solution A was deposited was cleaned with running water for 5 minutes, and then dried in an oven at 70° C. for 5 minutes so that a heat-resistant layer was formed. A nonaqueous electrolyte secondary battery laminated separator was thus obtained. Conditions under which the nonaqueous electrolyte secondary battery laminated separator was produced are summarized in Table 1. Properties of the nonaqueous electrolyte secondary battery laminated separator thus obtained are summarized in Table 2.

For obtainment of a DSC curve, the heat-resistant layer was removed by three times of peeling by use of a tape (Scotch, manufactured by 3M). A DSC measurement result and a current leakage occurrence rate are summarized in Table 3.

### Example 3

First, 80% by weight of ultra-high molecular weight polyethylene powder (GUR4012, manufactured by Ticona Corporation) and 20% by weight of polyethylene wax (FNP-0115, manufactured by Nippon Seiro Co., Ltd.) having a weight average molecular weight of 1,000 were prepared. That is, 100 parts by weight, in total, of the ultra-high molecular weight polyethylene powder and the polyethylene wax were prepared. To the ultra-high molecular weight polyethylene powder and the polyethylene wax, 0.4% by weight of an antioxidant (Irg1010, manufactured by Ciba Specialty Chemicals Corporation), 0.1% by weight of another antioxidant (P168, manufactured by Ciba Specialty Chemicals Corporation), and 1.3% by weight of sodium stearate were added. Further, calcium carbonate (manufactured by Maruo Calcium Co., Ltd.) having an average particle size of 0.1 μm was added so that the calcium carbonate accounted for 41% by volume of a total volume of all these compounds. The compounds were mixed in a powder state by use of a Henschel mixer, and melt-kneaded by use of a twin screw kneading extruder. A polyolefin resin composition was thus obtained.

The polyolefin resin composition was rolled by use of a pair of reduction rollers each having a surface temperature of 147° C., and then cooled in stages while being pulled by use of a winding roller that rotated at a speed different from that of the pair of reduction rollers (stretch ratio (winding roller speed/reduction roller speed): 1.4 times). A sheet having a film thickness of approximately 54 μm was thus prepared. This sheet was immersed in an aqueous hydrochloric solution (in which 4 mol/L of hydrochloric acid and 0.5% by weight of a non-ionic surfactant were blended) so that the calcium carbonate was removed, and then stretched 5.8-fold in the TD direction at 105° C. A porous film was thus obtained.

The coating solution A wets applied to one surface of the porous film, and deposited at a temperature of 50° C. and a humidity of 70% for 1 minute. The porous film on which the coating solution A was deposited was cleaned with running water for 5 minutes, and then dried in an oven at 70° C. for 5 minutes so that a heat-resistant layer was formed. A nonaqueous electrolyte secondary battery laminated separator was thus obtained. Conditions under which the nonaqueous electrolyte secondary battery laminated separator was produced are summarized in Table 1. Properties of the nonaqueous electrolyte secondary battery laminated separator thus obtained are summarised in Table 2.

For obtainment of a DSC curve, the heat-resistant layer was removed by three times of peeling by use of a tape (Scotch, manufactured by 3M). A DSC measurement result and a current leakage occurrence rate are summarized in Table 3.

### Examples 4

First, 80% by weight of ultra-high molecular weight polyethylene powder (GUR4012, manufactured by Ticona Corporation) and 20% by weight of polyethylene wax (FNP-0115, manufactured by Nippon Seiro Co., Ltd.) having a weight average molecular weight of 1,000 were prepared. That is, 100 parts by weight, in total, of the ultra-high molecular weight polyethylene powder and the polyethylene wax were prepared. To the ultra-high molecular weight polyethylene powder and the polyethylene wax, 0.4% by weight of an antioxidant (Irg1010, manufactured by Ciba Specialty Chemicals Corporation), 0.1% by weight of another antioxidant (P168, manufactured by Ciba Specialty Chemicals Corporation), and 1.3% by weight of sodium stearate were added. Further, calcium carbonate (manufactured by Maruo Calcium Co., Ltd.) having an average particle size of 0.1 μm was added so that the calcium carbonate accounted for 41% by volume of a total volume of all these compounds. The compounds were mixed in a powder state by use of a Henschel mixer, and melt-kneaded by use of a twin screw kneading extruder. A polyolefin resin composition was thus obtained.

The polyolefin resin composition was rolled by use of a pair of reduction rollers each having a surface temperature of 150° C., and then cooled in stages while being pulled by use of a winding roller that rotated at a speed different from that of the pair of reduction rollers (stretch ratio (winding roller speed/reduction roller speed); 1.4 times). A sheet having a film thickness of approximately 54 μm was thus prepared. This sheet was immersed in an aqueous hydrochloric solution (in which 4 mol/L of hydrochloric acid and 0.5% by weight of a non-ionic surfactant were blended) so that the calcium carbonate was removed, and then stretched 5.8-fold in the TD direction at 105° C. A porous film was thus obtained.

The coating solution B was applied to one surface of the porous film. The porous film to which the coating solution B was applied was dried in an oven at 70° C. for 5 minutes so that a heat-resistant layer was formed. A nonaqueous electrolyte secondary battery laminated separator was thus obtained. Conditions under which the nonaqueous electrolyte secondary battery laminated separator was produced are summarized in Table 1. Properties of the nonaqueous electrolyte secondary battery laminated separator thus obtained are summarized in Table 2.

For obtainment of a DSC curve, the heat-resistant layer was removed by (i) immersing the nonaqueous electrolyte secondary battery laminated separator in water, (ii) subjecting the nonaqueous electrolyte secondary battery laminated separator thus immersed in water to ultrasonic cleaning for 3 minutes, and (iii) drying, at a room temperature, the nonaqueous electrolyte secondary battery laminated separator thus cleaned. A DSC measurement result and a current leakage incidence are summarized in Tab. 3.

### Comparative Example 1

A porous film was produced in a manner similar to Example 1 disclosed in Japanese Patent Application Publication, Tokukai, No. 2011-032446, except that a sheet having a film thickness of 54 μm was prepared. The coating solution A was applied to one surface of the porous film, and deposited at a temperature of 50° C. and a humidity of 70% for 1 minute. The porous film on which the coating solution A was deposited was cleaned with running water for 5 minutes, and then dried in an oven at 70° C. for 5 minutes so that a heat-resistant layer was formed. A nonaqueous electrolyte secondary battery laminated separator was thus obtained. Conditions under which the nonaqueous electrolyte secondary battery laminated separator was produced are summarized in Table 1. Properties of the nonaqueous electrolyte secondary battery laminated separator thus obtained are summarized in Table 2.

For obtainment of a DSC curve, the heat-resistant layer was removed by three times of peeling by use of a tape (Scotch, manufactured by 3M). A DSC measurement result and a current leakage occurrence rate are summarized in Table 3.

### Comparative Example 2

First, 80% by weight of ultra-high molecular weight polyethylene powder (GUR4012, manufactured by Ticona Corporation) and 20% by weight of polyethylene wax (FNP-0115, manufactured by Nippon Seiro Co., Ltd.) having a weight average molecular weight of 1,000 were prepared. That is, 100 parts by weight, in total, of the ultra-high molecular weight polyethylene powder and the polyethylene wax were prepared. To the ultra-high molecular weight polyethylene powder and the polyethylene wax, 0.4% by weight of aft antioxidant (Irg1010, manufactured by Ciba Specialty Chemicals Corporation), 0.1% by weight of another antioxidant (P168, manufactured by Ciba Specialty Chemicals Corporation), and 1.3% by weight of sodium stearate were added. Further, calcium carbonate (manufactured by Maruo Calcium Co., Ltd.) having an average particle size of 0.1 μm was added so that the calcium carbonate accounted for 37% by volume of a total volume of all these compounds. The compounds were mixed in a powder state by use of a Henschel mixer, and melt-kneaded by use of a twin screw kneading extruder. A polyolefin resin composition was thus obtained.

The polyolefin resin composition was rolled by use of a pair of reduction rollers each having a surface temperature of 143° C., and then cooled in stages while being pulled by use of a winding roller that rotated at a speed different from that of the pair of reduction rollers (stretch ratio (winding roller speed/reduction roller speed): 1.4 times). A sheet having a film thickness of approximately 54 μm was thus prepared. This sheet was immersed in an aqueous hydrochloric solution (in which 4 mol/L of hydrochloric acid and 0.5% by weight of a non-ionic surfactant were blended) so that the calcium carbonate was removed, and then stretched 5.8-fold in a traverse direction (TD direction, width direction) at 105° C. A porous film was thus obtained.

The coating solution A was applied to one surface of the porous film, and deposited at a temperature of 50° C. and a humidity of 70% for 1 minute. The porous film on which the coating solution A was deposited was cleaned with running water for 5 minutes, and then dried in an oven at 70° C. for 5 minutes so that a heat-resistant layer was formed. A nonaqueous electrolyte secondary battery laminated separator was thus obtained. Conditions under which the nonaqueous electrolyte secondary battery laminated separator was produced are summarized in Table 1. Properties of the nonaqueous electrolyte secondary battery laminated separator thus obtained are summarized in Table 2.

For obtainment of a DSC curve, the heat-resistant layer was removed by three times of peeling by use of a tape (Scotch, manufactured by 3M). A DSC measurement result and a current leakage occurrence rate are summarised in Table 3.

### Comparative Example 3

The coating solution A was applied to a commercially-available polyolefin porous film (polyolefin separator), and deposited at a temperature of 50° C. and a humidity of 70% for 1 minute. The porous film on which the coating solution A was deposited was cleaned with running water for 5 minutes, and then dried in an oven at 70° C. for 5 minutes so that a heat-resistant layer was formed. A nonaqueous electrolyte secondary battery laminated separator was thus obtained. Properties of the nonaqueous electrolyte secondary battery laminated separator thus obtained are summarized in Table 2.

For obtainment of a DSC curve, the heat-resistant layer was removed by three times of peeling by use of a tape (Scotch, manufactured by 3M). A DSC measurement result and a current leakage occurrence rate are summarized in Table 3.

TABLE 1

| | Calcium | Reduction | | |
|---|---|---|---|---|
| | carbonate | roller | | |
| | content | temperature | Stretch | Coating |
| | (% by volume) | (° C.) | ratio | solution |
| Example 1 | 37 | 145 | 1.4 | A |
| Example 2 | 41 | 150 | 1.3 | A |
| Example 3 | 41 | 147 | 1.4 | A |
| Example 4 | 41 | 150 | 1.4 | B |
| Comparative | 38 | 150 | 1.0 | A |
| Example 1 | | | | |
| Comparative | 37 | 143 | 1.4 | A |
| Example 2 | | | | |

TABLE 2

| | | Weight | Weight | | |
|---|---|---|---|---|---|
| | | per | per unit | | |
| | | unit | area of | | |
| | | area of | heat- | | MD |
| | Film | porous | resistant | Air | elastic |
| | thickness | film | layer | permeability | force |
| | (μm) | (g/m²) | (g/m²) | (sec/100 cc) | (N/mm) |
| Example 1 | 15.9 | 6.2 | 1.8 | 205 | 21.5 |
| Example 2 | 14.1 | 6.0 | 2.0 | 194 | 15.5 |
| Example 3 | 14.4 | 5.9 | 2.0 | 182 | 17.4 |
| Example 4 | 15.0 | 5.6 | 5.2 | 120 | 18.7 |
| Comparative | 13.9 | 5.9 | 1.9 | 189 | 11.6 |
| Example 1 | | | | | |
| Comparative | 15.9 | 5.8 | 2.1 | 194 | 13.7 |
| Example 2 | | | | | |
| Comparative | 19.2 | 8.5 | 2.1 | 372 | 16.7 |
| Example 3 | | | | | |

TABLE 3

| | S_{PC}/S_{C} | Current leakage |
|---|---|---|
| Example 1 | 0.72 | 1 |
| Example 2 | 0.74 | 1 |
| Example 3 | 0.80 | 2 |
| Example 4 | 0.74 | 2 |
| Comparative | 0.69 | 6 |
| Example 1 | | |
| Comparative | 0.69 | 5 |
| Example 2 | | |
| Comparative | 0.82 | 4 |
| Example 3 | | |

As shown in Table 2, each of the nonaqueous electrolyte secondary battery laminated separators in accordance with respective Examples 1 through 4 and Comparative Examples 1 and 2 had a film thickness of not more than 20 μm, that is, it was so thin as to allow an increase in energy density. Furthermore, each of the nonaqueous electrolyte secondary battery laminated separators in accordance with respective Examples 1 through 4 and Comparative Examples 1 had a Gurley air permeability of not more than 250 sec/100 cc, that is, it had sufficient ion permeability. Despite having such a film thickness and ion permeability, each of the nonaqueous electrolyte secondary battery laminated separators in accordance with respective Examples 1 through 4 had S_{PC}/S_{C} falling within a range of 0.70 to 0.81, and had a current leakage occurrence rate of not more than 2. Namely, it was confirmed that each of the nonaqueous electrolyte secondary battery laminated separators in accordance with respective Examples 1 through 4 was less likely to cause a current leakage. In contrast, each of the nonaqueous electrolyte secondary battery laminated separators in accordance with respective Comparative Examples 1 and 2 had S_{PC}/S_{C} of less than 0.70, and had a current leakage occurrence rate of not less than 5. Namely, each of the nonaqueous electrolyte secondary battery laminated separators in accordance with respective Comparative Examples 1 and 2 was highly likely to cause a current leakage.

Though the nonaqueous electrolyte secondary battery laminated separator in accordance with Comparative Example 3 had a large weight per unit area (i.e., low air permeability) and contained a large amount of resin of which the nonaqueous electrolyte secondary battery laminated separator was made, it had S_{PC}/S_{C} of more than 0.81. That is, the nonaqueous electrolyte secondary battery laminated separator in accordance with Comparative Example 3 was highly likely to cause a current leakage.

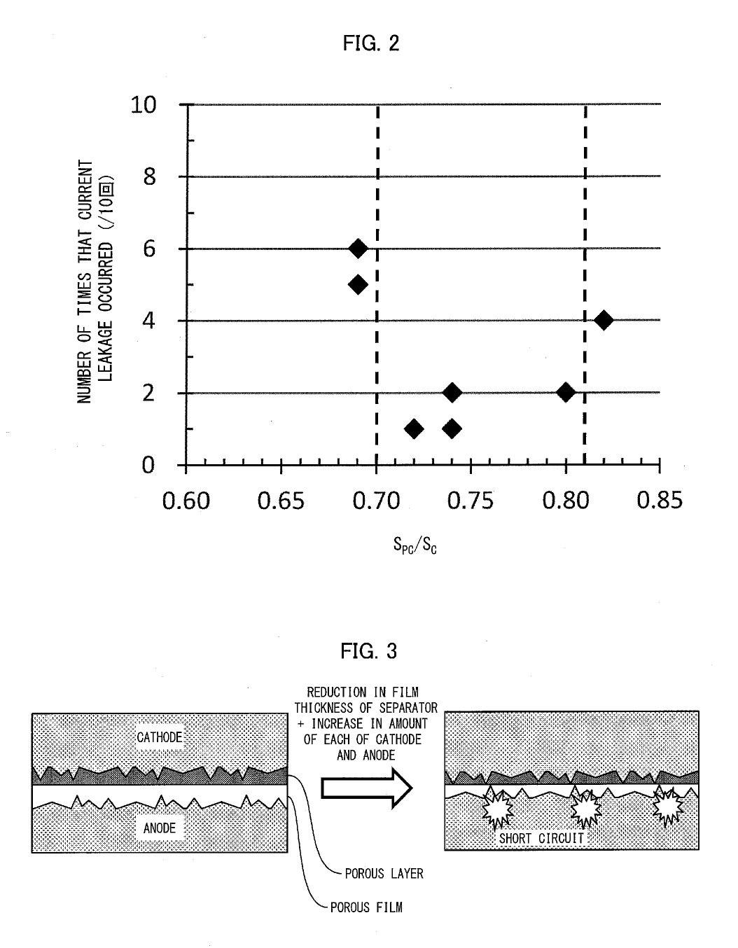

FIG. 2 is a graph showing how S_{PC}/S_{C} is related to the current leakage occurrence rate. It is found from FIG. 2 that, in a case where S_{PC}/S_{C} falls within a range of 0.70 to 0.81, it is possible to reduce the current leakage occurrence rate.

Moreover, since each of the nonaqueous electrolyte secondary battery laminated separators in accordance with respective Examples 1 through 4 included a heat-resistant layer, it was excellent in on-heating shape retainability. Furthermore, each of the nonaqueous electrolyte secondary battery laminated separators in accordance with respective Examples 1 through 4 had an MD elastic force of not less than 8 N/mm. That is, it was confirmed that each of the nonaqueous electrolyte secondary battery laminated separators in accordance with respective Examples 1 through 4 was excellent in handleability.

1. A nonaqueous electrolyte secondary battery laminated separator comprising:
a porous film containing not less than 50% by volume of polyolefin as a main component; and
a heat-resistant layer,
the nonaqueous electrolyte secondary battery laminated separator having a film thickness of 8 μm to 20 μm,
the nonaqueous electrolyte secondary battery laminated separator having a Gurley air permeability of not more than 250 sec/100 cc,
the nonaqueous electrolyte secondary battery laminated separator satisfying the following Expression (1):
0.70≦S_{PC}/S_{C}≦0.81 Expression (1)
where: S_{C} represents an area of an endothermic peak in a first DSC curve, the first DSC curve being obtained by performing differential scanning calorimetry (DSC) on pieces, each having a given size, that have been cut out from the nonaqueous electrolyte secondary battery laminated separator and that are stacked; and S_{PC} represents an area of part of the endothermic peak in the first DSC curve which part, overlaps an endothermic peak in a second DSC curve. the second DSC curve being obtained by performing DSC on pieces, each having a given size, that have been exit out from the porous film obtained by removing the heat-resistant layer from the nonaqueous electrolyte secondary battery laminated separator and that are stacked.

2. A nonaqueous electrolyte secondary battery member comprising:
a cathode;
a nonaqueous electrolyte secondary battery laminated separator recited in claim 1; and
an anode,
the cathode, the nonaqueous electrolyte secondary battery laminated separator, and the anode being provided in this order.

3. A nonaqueous electrolyte secondary battery comprising:
a nonaqueous electrolyte secondary battery laminated separator recited in claim 1.
